(19) United States
(12) Patent Application Publication
(10) Pub. No.: US 2004/0240198 A1
(43) Pub. Date: Dec. 2, 2004

(54) Automated self-illuminating sports & safety helmet

(76) Inventors: Ronald Joseph Van Laar, Simi Valley, CA (US); Kurt Daniel Van Laar, Simi Valley, CA (US)

Correspondence Address: RONALD J. VAN LAAR, 2624 CITRONELLA COURT, SIMI VALLEY, CA, 93063, US

(21) Appl. No.: 10/602,855

(22) Filed: May 28, 2003

(51) Int. Cl. F21V 21/084

(52) U.S. Cl. 362/105; 362/108; 362/84

(57) ABSTRACT

A intelligent sports and safety helmet designed for bicyclists, skateboarders, snowboarders, skiers, other sports enthusiast as well as industrial, military and security services that utilizes a helmets or head protection while performing an activity or duty. The helmet consists of a sports or safety helmet with a Microprocessor, a set of sensors and a software program residing within the microprocessor. In operation electronic sensors automatically detect if the user is wearing helmet and if environmental conditions warrant self-illumination. The microprocessor manages the state of the illuminating elements.

### STATEMENT OF FEDERALLY SPONSORED RESEARCH

There is NO Federal Sponsorship.

### FIELD OF INVENTION

This invention relates to safety helmets for sporting and industrial use, in particular Self illuminated by any integral light source, in particular such sources as LED's, EL Lamps or any electro-luminesceing materials wherein the illumination is managed by a micro computer and sensors.

### BENEFITS OF INVENTION

The primary benefit is safety, especially amongst the younger users such as children that will some times forget to activate any devices. The Automatic safety helmet is not dependent upon the user, but automatically detects that the user is in fact present and that the level of darkness is adequate to start up on it's own. Ultimately protecting all users, the user could be totally unaware that of the environmental conditions have changed and that they should be utilizing alternative lighting safety concepts. The Automatic Safety helmet will automatically detect that the user is wearing the helmet and automatically activate itself.

### BACKGROUND OF THE INVENTION

Since most outdoor sports activities either require, or should require a safety helmet while performing that activity There is a need for intelligent safety equipment. Statistics show that most accidents between sports enthusiasm such as bicyclists, skateboarder's, roller-bladder's and automobiles occur during the evening or twilight hours. A major contributing factor behind the majority of these accidents is the lack of visibility.

Today's safety features for cyclists and other sporting activities are inadequate. The use of reflectors and or reflective tape alone, do not do an adequate job of creating necessary visibility. Each year, approximately 550,000 persons are treated in emergency rooms for injuries related to bicycle riding and other sporting activities. About 1000 bicycle riders are killed in the US each year usually involving collisions with cars 75% of the deaths are do to head injuries. Many head injuries can be prevented by wearing head protection, but that still does not solve the problem of inadequate visibility of the user or rider. Studies show us that during the twilight hours, or the time when the sun is setting till the time it's actually dark visibility is at it's lowest point. As one drives a vehicle or performs a sporting activity during this time the chances of an accident are dramatically increased. Especially if that rider, or sports enthusiastic is wearing dark colored clothing.

In order to help lower such incidents from occurring, there is a demand for the intelligent self-illuminating sports safety helmet. A helmet that will protect the user by generating additional visibility with illumination and help prevent accidents before they happen because drivers and others will be able to see them at greater distances, greatly increasing chances of a driver seeing the helmet, preventing an accident.

### BRIEF SUMMARY OF THE INVENTION

The intelligent safety helmet is a combination of electronic sensors a microprocessor and software that automatically detect if the user is wearing helmet, and the conditions are correct for self illumination. The idea is to create a design that incorporates safety and technology while still remaining extremely user friendly.

This is the only design that is specifically engineered to be self-activated. When children are engaged in activities they seldom notice the time of day verses the lighting conditions, The unit has its own checks and balances, turning on and off without user intervention. Illumination elements come in a variety of different colors, so individual elements can be created providing striking arrays of colors. The software is capable of causing the illumination elements to flash, hold steady state or flash in patterns, bringing even more attention to the user.

### DESCRIPTION OF RELATED ART

The concept of adding a lighting apparatus or device to headgear has been around for many years. Ever since early miners and other workers in dimly lit situations, Attached candles, kerosene lamps, Carbide lamps or incandescent low voltage lamps to their helmets to see better. Although prior art is known in this field, no other prior art has come up with an interrogated and automated design. Many have tried to created safety helmets that would produce some sort of light as a means of protection for the user. Their creations usually contain manual switching on and off. None provide any environmentally aware sensors or built in intelligence with the notable exception of U.S. Pat. No. 6,012,822 where in Robinson proposed using a motion switch to turn on and off his flasher circuit to flash a pair of LED's on ones clothing but, the motion switch only an on /off function with no intelligence.

In U.S. Pat. No. 5,357,409 by Terry L Glatt titled Illuminated Safety Helmet. This design utilizes a series of light emitting diodes or LED's to create a lighting source. This produces a lower level of light then an Electroluminescent or phosphors strip and consumes more power while producing more heat. Further the design is limited to manual switching restrictions were as the user has to remember to active the unit.

U.S. Pat. No. 5,327,587 titled Illuminated Safety Helmet by Marni Hurwitz does utilize one electroluminescent strip or EL lamp. However with this design of just placing one EL lamp strip in the center of the helmet will not provide adequate visibility for the intended use. With a single strip in center of the helmet, little or no visibility will be achieved around the sides or area that will be visible towards others. This design is also limited to manual switching restrictions were the user has to remember to active the unit.

U.S. Pat. No. 5,544,027 titled LED Display for protective Helmet and Helmet Containing Same. By Orsano, This design uses of LED's or light emitting diodes, basically attached to double sided tape or Velcro and adhered to a helmet exterior. This design has the same issues as other LED designs as consuming more power relative to the quaintly of light produced. In Orsano's climes he suggests a computer chip could used to sequence the LED array replacing the simple Flip-Flop counter sequencer in the current implementation. This design is limited to manual switching were the user has to remember to activate the unit.

In U.S. Pat. No. 5,588,736 by Raymond E Shea Sr. titled Self lighted safety helmet He talks about a self lighting helmet only to have manual switching system? Nothing in this design is self-activated; this design method relies on user intervention to activate.

In U.S. Pat. No. 5,559,680, titled Electroluminescent Bicycle Helmet, by Dennis A. Tabanera described as having a structural foam liner, a plastic shell overlay and an electroluminescent lamp film located between the liner and the shell. The battery and inverter are housed in pockets on opposite sides of the helmet. This design is limited to manual switching restrictions were the user has to remember to activate the unit. This design also incorporates only a single light source that would make replacement difficult to near impossible. Also having the battery and inverter imbedded in the sides of the helmet would affect the structural integrity of the helmet and actually create more of a hazard if the user were to have an impact in those areas.

In U.S. Pat. No. 6,007,213 titled Illuminated safety helmet by Michael P Baumgartner, the only difference between his design and all other pervious art is that he is utilizing a different lighting element. Instead of LED's or a an electroluminesent strips this design uses a single light source and fiber optic conduit. The end result is the same. The design is limited to manual switching restrictions were as the user has to remember to active the unit. Also while reviewing the drawings in the above referenced patent FIG. 1, 2, and 3 it seems that little or no light will be emitted. The lighting element on the back and sides is placed much to high to be seen from any other place then from directly above the user, rendering this design useless for actually promoting extra visibility. Furthermore as illustrated in this designs FIG. 1 the lighting element is directly in front of the users eyes creating a problem for the user to see. A design like this would actually be more of a safety hazard then a protective element.

In U.S. Pat. No. 6,309,764 titled Elastomeric EL lamp on apparel a methodology of screening EL lamps onto an elastomeric substrate and over coated with a second elastomeric layer. Clime 16 references a hat and a pocket to contain a battery and inverter, however there is no mention of a microprocessor, light or motion sensing

As far as the claims that any EL Lamp light not last with today's technology the replacement of EL lamp strips or panels are at a minimal cost and effort. EL lamp comes in a variety of colors and can easily be created into many shapes and patterns.

Also having individual LED's imbedded in the helmet makes replacement of individual bulbs difficult to near impossible. Having a cut away or detachable section seems that it would decrease the structural integrity of the helmet itself and also limit manufacturing methods.

In U.S. Pat. No. 6,499,145 Kates is claiming to put a glowing element on a baseball hat which is the similar to the set of clams enumerated in 5,111,366 by Rife in May, 1992 with the exception of using an El-lamp as the illumination source. There is no microprocessor or sensors used to manage the illumination.

### BRIEF DESCRIPTION OF THE DRAWINGS

FIG. 1. This is an overall lay out of electronic components where in 10 is El-Lamps, electroluminescent lamps, High voltage AC lines 30 and High voltage AC return lines 40 provide the high voltage drive to the El-Lamps from the Inverters 20. The Microprocessor 100 turns on and off the inverters 20 via inverter control lines 60. The Multiple axis accelerometer 90 detects any movement of the helmet and the Photo Detector 110 is used to evaluate ambient light levels. The Battery 50 is the power source for the electronics.

FIG. 2. This drawing depicts the placement of the El-Lamps 10 on the periphery of the helmet. The Logic module 120 is mounted on the top of the helmet with the Multiple axis accelerometer 90, the Microprocessor 100 and 110 Photo Detector arranged on the logic board. The battery 50 is mounted on the rear of the helmet ether on the outer surface or below the transparent outer shell of the helmet.

FIG. 3. This view shows the placement of the battery 50 and the logic module 120.

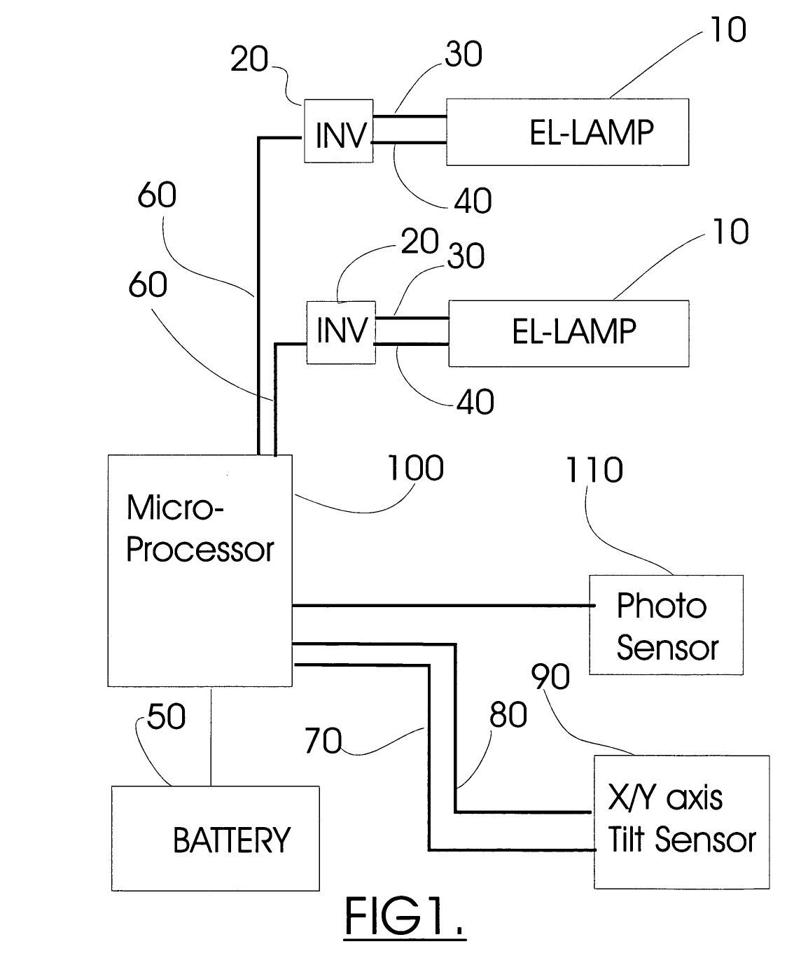

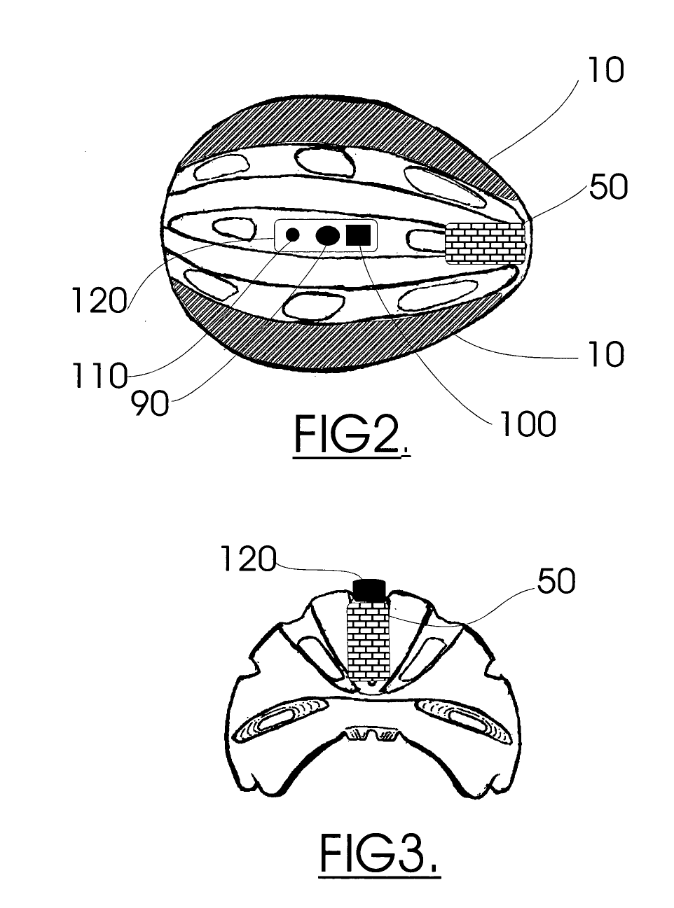

### DETAILED DESCRIPTION OF THE INVENTION

How it Works Because this design must be set up in such a manner that it does not require any user intervention. The microprocessor will constantly read it's set of sensors. In order to conserve power the system will use the power management capabilities of the microprocessor.

Event Sequence

The logical sequence is as follows:

1. The Microprocessor will first verify if the unit is plugged into the battery charger. If plugged into charger the process will wait until Charger Present Flag is cleared. If the helmet is not in the charger the program will continue to the next state.

2. Next the microprocessor reads the light sensor. If light level is too high or to bright the process will loop in this state. If light level is low enough, the microprocessor steps to the next sequence.

3. The next step is for the microprocessor to read the accelerometer to see if any motion has been detected. This is to assure that the helmet is actual in use and not just sitting in a dark closet on a shelf, or something to that affect. If motion is detected the next state is entered.

4. If the unit is not plugged in to a charger, the light level is within a pre-determined level and the accelerometers are detecting motion then the Microprocessor will turn on the light elements to a programmatically selected operating state. Those states include flashing, steady state or sequencing depending on the light level and forward motion as well as specific requests. If sensor data indicates out range conditions, the microprocessor knows how to handle the condition. If the unit has been on it will programmatically generate a delay before turning off the lamps, so passing under lights or stopping at a stop light will not deactivate the unit.

What is claimed:

1. A sports or Safety helmet where in:
a. A microprocessor or micro-computer is used to control the elimination of at least one electroluminesent lamp.
b. An multi axis accelerometer is used to detect motion and provides motion data to the processor.
c. An photo detector provides ambiance light level data to the processor.
d. d. An algorithm is resident in the ROM or Flash memory of the processor to manage the state of the El-lamps using light level and motion data as decision input parameters.

2. Helmet with controls as described in claim 1, wherein the photo sensor is a photo diode.

3. Helmet with controls as described in claim 1, wherein the photo sensor is a silicon photo cell.

4. Helmet with controls as described in claim 1, wherein the photo sensor is a cadmium sulfide or equivalent photo sensing device.

5. Helmet with controls as described in claim 1, wherein the accelerometer are multi axis vibration sensors

6. Helmet with controls as described in claim 1, wherein tilt sensor including but not limited to fluid filled and or magnetic devices for motion detection.

7. Helmet with controls as described in claim 1, wherein a battery-charging unit is detected in the algorithm.

8. Helmet with controls as described in claim 1, wherein illumination output elements are Light Emitting Diodes or arrays of Light Emitting Diodes.

9. Helmet with controls as described in claim 1, wherein illumination output elements are an organic phosphor.

10. Helmet with controls as described in claim 1 wherein illumination output is of multiple elements of mixed types, i.e. El-Lamps and LES's.

11. Helmet with controls as described in claim 10, were as multiple lighting elements can be sequenced or manipulated by software algorithms based on sensor inputs.

12. Helmet with controls as described in claim 10, were batteries can be conformal to outer geometry of helmet.

13. Helmet with controls as described in claims 1 though 12, wherein the power source is a fuel cell.

14. Helmet with controls as described in claims 1 though 13, wherein the power source is a rechargeable.
